(19) United States
(12) Patent Application Publication
(10) Pub. No.: US 2002/0006323 A1
(43) Pub. Date: Jan. 17, 2002

(54) Semiconductor processing system and transfer apparatus for the same

(76) Inventors: Tetsuo Yoshida, Nirasaki-shi (JP); Yoshiaki Sasaki, Nirasaki-shi (JP); Hiroaki Saeki, Nirasaki-shi (JP); Masaki Kondo, Nirasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/898,056

(22) Filed: Jul. 5, 2001

(30) Foreign Application Priority Data
Jul. 12, 2000 (JP) 2000-211875

(51) Int. Cl. B65G 1/00

(52) U.S. Cl. 414/217

(57) ABSTRACT

A transfer apparatus for transferring a semiconductor wafer in a semiconductor processing system includes first and second support portions each for supporting the wafer. The first and second support portions have structures and functions different from each other. The first support portion is provide with backside receiving members having horizontal surfaces to come into contact with the backside of the wafer. The second support portion is provided with edge receiving members having slant surfaces to come into contact with the edge of the wafer. The first and second support portions are selectively used to prevent the wafer from positionally shifting.

### CROSS-REFERENCE TO RELATED APPLICATIONS

This application is based upon and claims the benefit of priority from the prior Japanese Patent Application No. 2000-211875, filed Jul. 12, 2000, the entire contents of which are incorporated herein by reference.

### BACKGROUND OF THE INVENTION

The present invention relates to a semiconductor processing system, and a transfer apparatus for transferring a target substrate, such as a semiconductor wafer, in a semiconductor processing system. The term “semiconductor process” used herein includes various kinds of processes which are performed to manufacture a semiconductor device or a structure having wiring layers, electrodes, and the like to be connected to a semiconductor device, on a target substrate, such as a semiconductor wafer or an LCD substrate, by forming semiconductor layers, insulating layers, and conductive layers in predetermined patterns on the target substrate.

In a process of manufacturing a semiconductor device, a transfer apparatus is used to transfer a target substrate, such as a semiconductor wafer, between different chambers such as a cassette chamber, a process chamber, and a transfer chamber. As a transfer apparatus of this kind, there is known a structure having only one support portion for supporting a wafer, and a structure having a plurality of, e.g., two, support portions, as disclosed in Jpn. Pat. Appln. KOKAI Publication No. 11-163077, and Jpn. Pat. Appln. KOKAI Publication No. 11-284044. In recent years, a transfer apparatus having a plurality of support portions is becoming popular, because of a high transfer efficiency. For example, where a transfer apparatus has two support portions, the two support portions are constituted to have substantially the same structure, shape, and function, as each other. The two support portions are used appropriately, e.g., alternately, so as to increase the throughput of a process.

A support portion of a transfer apparatus of this kind for placing a wafer thereon is provided with a plurality of receiving members attached thereto. The receiving members are made of a material having a high friction coefficient, such as a silicone-based rubber, e.g., Kalrez(™). The receiving members are intended to prevent the wafer from sliding off the support portion during transfer. As the support portion is used for transferring wafers many times, dust sticks to the surface of the receiving members and can reduce the friction coefficient of the surface of the receiving members (which are made of silicone-based rubber). If the friction coefficient of the surface of the receiving members decreases, a wafer may laterally slide and cause a positional shift during transfer.

Where the positional shift is caused on the upstream side from a positioning mechanism for positioning wafers, this is not serious. On the other hand, where the positional shift is caused on the downstream side from the positioning mechanism, a wafer may be transferred into a process chamber in an undesirably shifted state. In addition, the positional shift tends to be accumulated upon each transfer, and thus, where a wafer is sequentially processed over a plurality of process chambers, the processes respectively performed in the process chambers are affected more by the positional shift on the downstream side.

### BRIEF SUMMARY OF THE INVENTION

An object of the present invention is to provide a semiconductor processing system and a transfer apparatus for the same, which suppresses the generation or accumulation of the positional shift of a target substrate during transfer of the substrate.

According to a first aspect of the present invention, there is provided a transfer apparatus for transferring a target substrate in a semiconductor processing system, comprising:

a common base;

an intermediate section disposed on the common base and configured to be pivotable and extensible/contractible; and

a pickup section connected to the intermediate section and having first and second support portions each configured to support the target substrate, the first and second support portions having functions different from each other.

According to a second aspect of the present invention, there is provided a semiconductor processing system comprising:

a transfer chamber;

a cassette chamber connected to the transfer chamber and configured to accommodate a cassette configured to hold a plurality of target substrates;

a vacuum processing section connected to the transfer chamber and configured to subject a target substrate to a process in a vacuum atmosphere;

a positioning mechanism disposed in or connected to the transfer chamber and configured to subject the target substrate to a positioning operation;

a transfer apparatus disposed in the transfer chamber and configured to transfer the target substrate between the cassette chamber, the vacuum processing section, and the positioning mechanism, the transfer apparatus comprising a common base, an intermediate section disposed on the common base and configured to be pivotable and extensible/contractible, and a pickup section connected to the intermediate section and having first and second support portions each configured to support the target substrate, the first and second support portions having functions different from each other; and

a control section configured to control the transfer apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic diagram showing a semiconductor processing system, which includes a transfer apparatus according to an embodiment of the present invention;

FIG. 2 is a perspective view showing the transfer apparatus in the system shown in FIG. 1;

FIG. 3 is a plan view showing a first support portion in the transfer apparatus shown in FIG. 2;

FIG. 4 is a side view of the first support portion shown in FIG. 3;

FIG. 5 is a plan view showing a second support portion in the transfer apparatus shown in FIG. 2;

FIG. 6 is a side view of the second support portion shown in FIG. 5;

FIG. 7 is a perspective view showing an edge receiving member in the second support portion shown in FIG. 5;

FIG. 8 is a schematic diagram showing a semiconductor processing system of a cluster-tool type, which includes a transfer apparatus according to another embodiment of the present invention;

FIG. 9 is a perspective view showing the transfer apparatus in the system shown in FIG. 8;

FIG. 10 is a plan view showing a second support portion in the transfer apparatus shown in FIG. 9;

FIG. 11 is a side view of the second support portion shown in FIG. 10; and

FIG. 12 is a side view for explaining functions of the second support portion shown in FIG. 10.

### DETAILED DESCRIPTION OF THE INVENTION

Embodiments of the present invention will be described hereinafter with reference to the accompanying drawings. In the following description, the constituent elements having substantially the same function and arrangement are denoted by the same reference numerals, and a repetitive description will be made only when necessary.

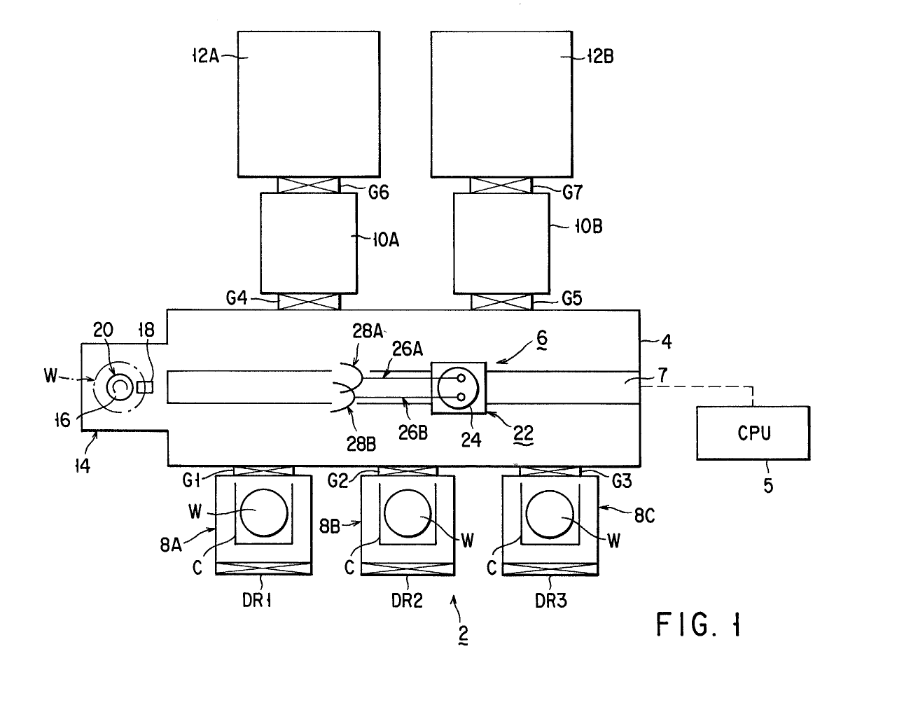

FIG. 1 is a schematic diagram showing a semiconductor processing system, which includes a transfer apparatus according to an embodiment of the present invention. As shown in FIG. 1, the semiconductor processing system 2 includes a transfer chamber 4 formed of a rectangular box of, e.g., stainless steel. A guide rail 7 is disposed in the transfer chamber 4 and extends along the longitudinal direction of the chamber 4, and a transfer apparatus 6 is slidably supported on the rail 7.

Three cassette chambers 8A, 8B, and 8C are connected to one side of the transfer chamber 4 through gate valves G1, G2, and G3, respectively. Each of the cassette chambers 8A to 8C is arranged to accommodate a cassette C, which can hold a plurality of, e.g., 25, target substrates, such as semiconductor wafers, in a stacked state at predetermined intervals. Cassette doors DR1, DR2, and DR3 are respectively arranged on the sides of the cassette chambers 8A to 8C, opposite to the transfer chamber 4 sides, for transferring cassettes C between the system and the outside. The transfer chamber 4 and the cassette chambers 8A to 8C are kept at atmospheric pressure (generally in the atmosphere of a clean room).

Two load-lock chambers 10A and 10B are connected to the side of the transfer chamber 4, opposite to the cassette chambers 8A to 8C side, through gate valves G4 and G5, respectively. Vacuum process chambers 12A and 12B are connected to the sides of the load-lock chambers 10A and 10B, opposite to the transfer chamber 4 sides, through gate valves G6 and G7, respectively. In each of the vacuum process chambers 12A and 12B, a wafer W is subjected to a semiconductor process, such as oxidation, diffusion, film formation, etching, or annealing, under a vacuum atmosphere.

Each of the load-lock chambers 10A and 10B is provided therein with a worktable (not shown) for placing a wafer W, and a transfer arm (not shown) for transferring the wafer between the load-lock chamber 10A or 10B and the process chamber 12A or 12B. The load-lock chambers 10A and 10B are capable of being vacuum-exhausted and being N₂-purged.

A positioning chamber 14 is connected to one side of the transfer chamber 4 in the longitudinal direction, and is opened to the transfer chamber 4. The positioning chamber 14 is provided therein with a positioning mechanism 20 for detecting the positional shift of a wafer W and positioning the wafer W. The positioning mechanism 20 is mainly constituted of a worktable 16 rotatable along with the wafer W and an optical system 18 for detecting the edge of the wafer W.

In the semiconductor processing system 2, the operations of the transfer apparatus 6, the cassette chambers 8A to 8C, the load-lock chambers 10A and 10B, and the positioning mechanism 20 are controlled in accordance with a program stored in a CPU 5, which works as a control section.

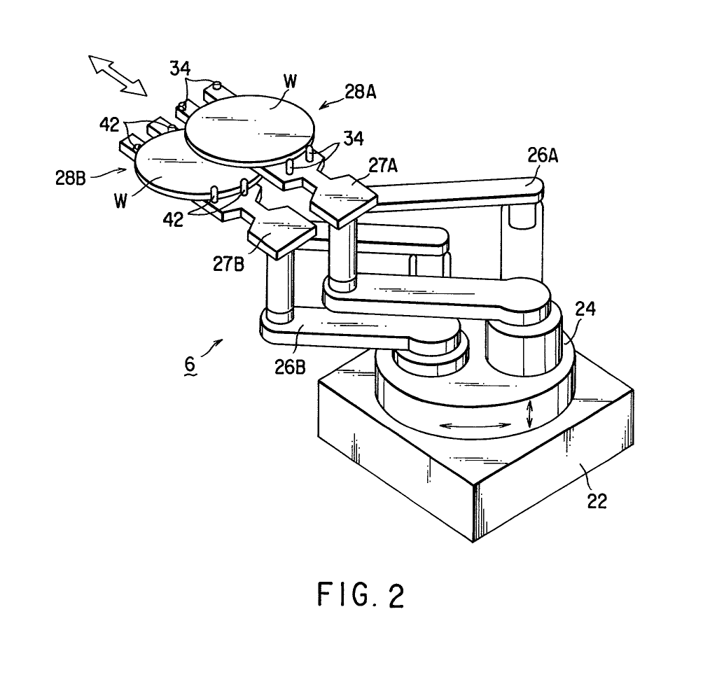

FIG. 2 is a perspective view showing the transfer apparatus 6. The transfer apparatus 6 includes a traveling base 22, an intermediate section disposed on the traveling base 22 and arranged to be pivotable and extensible/contractible, and a pickup section connected to the intermediate section and arranged to engage with a wafer W. The intermediate section of the transfer apparatus 6 has a single rotational table 24 disposed on the traveling base 22 and arranged to be rotatable and elevatable, and first and second extensible/contractible arms 26A and 26B disposed on the rotation table 24 and arranged to be extensible/contractible independently of each other by, e.g., multi-joint mechanisms. The pickup section has first and second pick arms 27A and 27B connected to the first and second extensible/contractible arms 26A and 26B, respectively, and made of, e.g., a ceramic. The first and second pick arms 27A and 27B are provided with first and second support portions 28A and 28B, respectively, each for supporting the wafer W. The first and second support portions 28A and 28B have structures and functions different from each other.

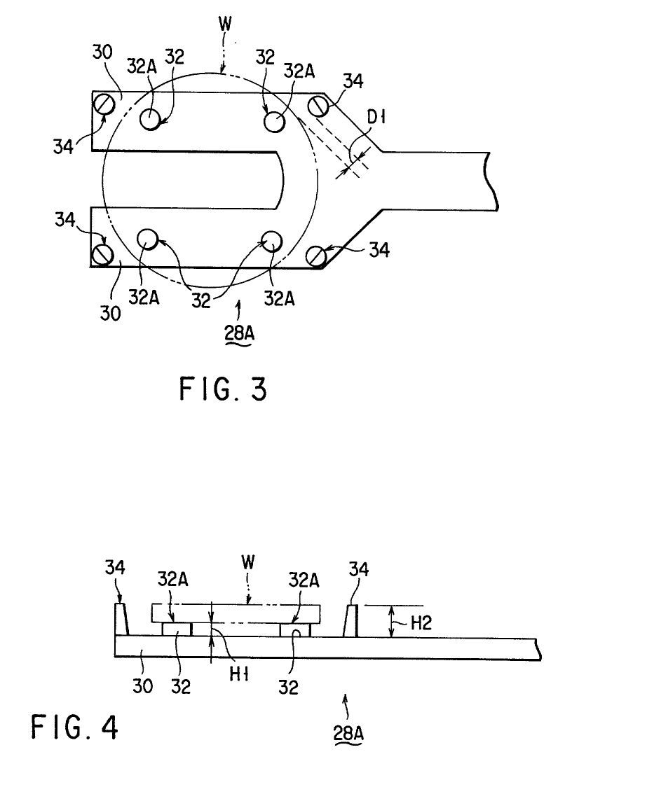

FIGS. 3 and 4 are a plan view and a side view, respectively, showing the first support portion 28A. The first support portion 28A has a support plate 30 with a distal end divided into two portions. The support plate 30 is provided with three or more backside receiving members 32 located within the plan-view contour of the wafer at the normal position. In this embodiment, four backside receiving members 32 are uniformly disposed at the corners of a rectangle. The backside receiving members 32 are made of an elastic material having a high friction coefficient, such as silicone-based rubber. The diameter and the height H1 of the backside receiving members 32 are set at about 7.6 mm, and at about 0.2 mm, respectively. The backside receiving members 32 respectively have horizontal surfaces 32A at the top ends. The horizontal surfaces 32A come into contact with the backside of the wafer W, so that they support the weight of the wafer W.

Around the backside receiving members 32, there are three or more, in this embodiment, four, stoppers 34 having a height H2 larger than that of the backside receiving members 32. The stoppers 34 are made of an elastic material, such as silicone-based rubber. The height of the stoppers 34 is set at, e.g., about 0.8 mm in light of the thickness of the wafer W. Even if the wafer W laterally slides on the backside receiving members 32, the edge of the wafer W comes into contact with the stoppers 34, so that the wafer W is prevented from further sliding, and thus from falling off.

The first support portion 28A has a larger tolerance for the positional shift of the wafer W, and a smaller thickness, than the second support portion 28B does. The positional shift tolerance of the first support portion 28A is set to fall in a range of from 2 to 3 mm. In this embodiment, the distance D1 between the edge of the wafer at the normal position and the stoppers 34, i.e., the positional shift tolerance, is set at, e.g., about 2.5 mm. Even when the wafer W has some positional shift, the first support portion 28A can reliably receive the wafer W with the positional shift, so long as the positional shift falls in the tolerance range.

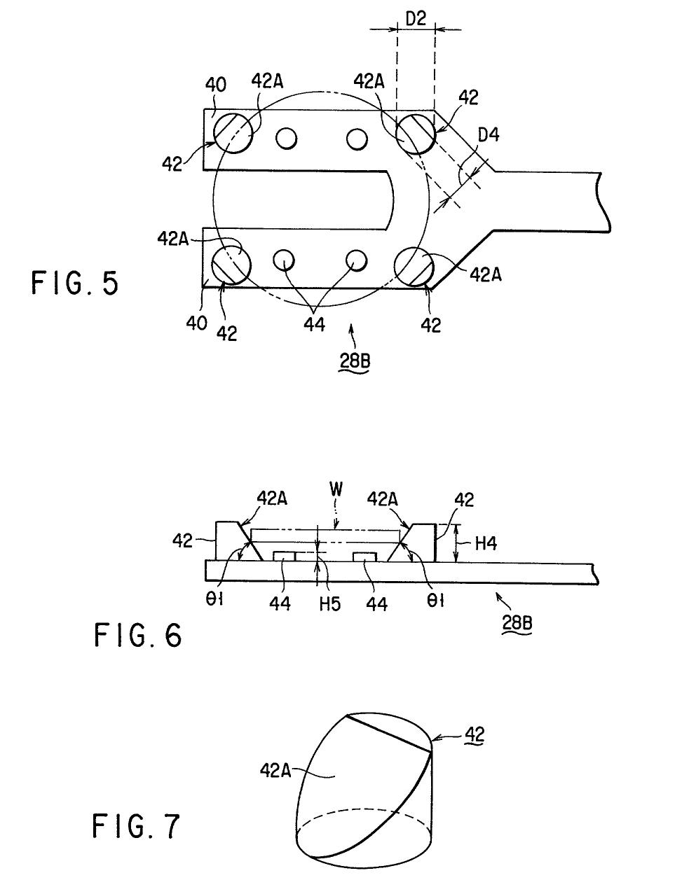

FIGS. 5 and 6 are a plan view and a side view, respectively, showing the second support portion 28B. The second support portion 28B has a support plate 40 with a distal end divided into two portions. The support plate 40 is provided with three or more edge receiving members 42 located across the plan-view contour of the wafer at the normal position. In this embodiment, four edge receiving members 42 are uniformly disposed at the corners of a rectangle. The edge receiving members 42 are made of an elastic material having a high friction coefficient, such as silicone-based rubber. The diameter D2 of the edge receiving members 42 are set at about 4 mm. The edge receiving members 42 respectively have slant surfaces 42A inclined downward toward the wafer center. The slant surfaces 42A come into contact with the edge of the wafer W, so that they support the weight of the wafer W.

In the case of the first support portion 28A, the wafer W may laterally slide to generate a positional shift during transfer of the wafer W, after the backside receiving members 32 are degraded. However, in the case of the second support portion 28B, since the wafer edge is supported on the slant surfaces 42A, the wafer W is prevented from laterally sliding to generate a positional shift during transfer of the wafer W, even after the edge receiving members 42 are degraded. In other words, the second support portion 28B works as a support portion with a function of preventing the positional shift.

The height H4 of the edge receiving members 42 is set at, e.g., about 1.0 mm in light of the thickness of the wafer W. The tilting angle θ1 of the slant surfaces 42A is set at, e.g., about 30° in light of the friction between the slant surfaces 42a and the wafer W, and such that the edge receiving members 42 are not too high. The length D4 (see FIG. 5) of the slant surfaces 42A in the direction toward the wafer center is set at about 1.6 mm, in light of the maximum tolerance for the positional shift of the wafer W.

In other words, the second support portion 28B has a smaller tolerance for the positional shift of the wafer W than the first support portion 28A. The second support portion 28B may be formed of a structure in which the distance D1 between the wafer edge and the stoppers 34 in FIG. 3, i.e., the positional shift tolerance, is set to fall in a range of from about 0.1 to 0.3 mm, and at, e.g., about 0.2 mm, in place of the structure shown in FIGS. 5 and 6.

On the inner side of the edge receiving members 42, there are three or more, in this embodiment, four, auxiliary receiving members 44 having a height smaller than that of the edge receiving members 42. The auxiliary receiving members 44 are made of an elastic material having a high friction coefficient, such as silicone-based rubber. The height H5 (see FIG. 6) of the auxiliary receiving members 44 is set at, e.g., about 0.2 mm, so that it is lower than the substantial portion of the slant surfaces 42A. The auxiliary receiving members 44 respectively have horizontal surfaces at the top ends. Even if the wafer W positionally shifts more than the maximum tolerance, the horizontal surfaces of the auxiliary receiving members 44 come into direct contact with the backside of the wafer W, so that they support the weight of the wafer W.

An explanation will be given of a manner of transferring a wafer W in the semiconductor processing system shown in FIG. 1. The operations described below of the transfer apparatus 6 and so forth for transferring the wafer W in the semiconductor processing system shown in FIG. 1 are controlled in accordance with a program stored in the CPU 5.

A plurality of new wafers are held in a cassette accommodated in any one of the cassette chambers 8A to 8C. One of the wafers W is taken out and placed on the worktable 16 of the positioning mechanism 20 by the transfer apparatus 6. While the worktable 16 is rotated, the edge of the wafer W is observed by the optical system 18, so that the wafer W is subjected to a positioning operation.

The wafer W treated in the positioning mechanism 20 is supported by the transfer apparatus 6 at a position without any positional shift, and is transferred into either one of the load lock chambers, e.g., the load lock chamber 10A. Then, the wafer W is transferred from the load lock chamber 10A into the process chamber 12A by the transfer arm (not shown) arranged in the load lock chamber 10A.

After the wafer W is subjected to a predetermined process in the process chamber 12A, the wafer W is transferred from the process chamber 12A into the load lock chamber 10A by the transfer arm (not shown) arranged in the load lock chamber 10A. Then, the wafer W is supported by the transfer apparatus 6, and is transferred into a cassette for holding processed wafers W.

When the new wafer W is transferred from the cassette chambers 8A to 8C to the positioning mechanism 20, the first support portion 28A having a larger positional shift tolerance shown in FIGS. 3 and 4 is used. On the other hand, when the wafer W is transferred from the positioning mechanism 20 to the process chambers 12A and 12B, i.e., to the load lock chambers 10A and 10B, the second support portion 28B having a function of preventing the positional shift shown in FIGS. 5 and 6 is used.

In this respect, specifically, wafers W may have positional shifts in various directions within a cassette C, so long as the positional shift tolerance given by the hardware allows. The positional shifts are caused by, e.g., the wafers W laterally sliding in the cassette C when the cassette C is carried automatically or manually.

For this reason, when a wafer W is transferred from the cassette C, the first support portion 28A shown in FIGS. 3 and 4 is used. The wafer W is transferred to the positioning mechanism 20 by the first support portion 28A, while the backside of the wafer W is supported by the horizontal surfaces 32A of the backside receiving members 32. Accordingly, even when the wafer W has a positional shift in the cassette C, it is reliably received by the first support portion 28A.

As the first support portion 28A is repeatedly used, the backside receiving members 32 are degraded, and the friction coefficient of the horizontal surfaces 32A decreases. In this case, the wafer W may laterally slide when the wafer W is transferred. Even when the wafer W laterally slides, the edge of the wafer W comes into contact with the stoppers 34, so that the wafer W is stopped. As a result, the wafer W is prevented from falling off the first support portion 28A.

The height H2 of the stoppers 34 is set at a value with which the stoppers 34 do not interfere with a wafer above the wafer W to be transferred in the cassette C, when the first support portion 28A enters the cassette C to take out the wafer W. Although the wafer W cannot be prevented from falling off, such a structure may be employed that the four stoppers 34 are omitted from the first support portion 28A.

On the other hand, when the positioned wafer W is transferred from the positioning mechanism 20 to the process chambers 12A and 12B, the second support portion 28B having a function of preventing the positional shift is used. The direction and amount of positional shift of the wafer W are specified by the positioning mechanism 20, and the second support portion 28B is positionally controlled in the horizontal coordinate system to cancel the positional shift when it receives the wafer W.

On the second support portion 28B, the slant surfaces 42A of the edge receiving members 42 come into direct contact with edge of the wafer W, so that they support the weight of the wafer W by means of four-point supporting. Consequently, the wafer W is supported by the second support portion 28B without any positional shift, while it is transferred to the load lock chambers 10A and 10B (i.e., to the process chambers) by the second support portion 28B.

As the second support portion 28B is repeatedly used, the edge receiving members 42 are degraded, and the friction coefficient of the slant surfaces 42A decreases. However, unlike the first support portion 28A, the second support portion 28B supports the wafer W, while the wafer edge is caught by the slant surfaces 42A. Consequently, the wafer W hardly positionally shifts on the second support portion 28B.

Even when the wafer edge slides on the slant surfaces 42 during transfer, the wafer backside is supported by the auxiliary receiving members 44 having a lower height H5. Accordingly, the wafer W is prevented from positionally shifting beyond the tolerance, and the wafer edge is prevented from hitting the support plate 40 of the second support portion 28B.

When the processed wafer W is transferred from the process chambers 12A and 12B (i.e., from the load lock chambers 10A and 10B, respectively) to the cassette C, either one of the first and second support portions 28A and 28B can be used in the semiconductor processing system 2 shown in FIG. 1. Although the semiconductor processing system 2 shown in FIG. 1 has the two process chambers 12A and 12B, the present invention may be applied to a system having only one process chamber.

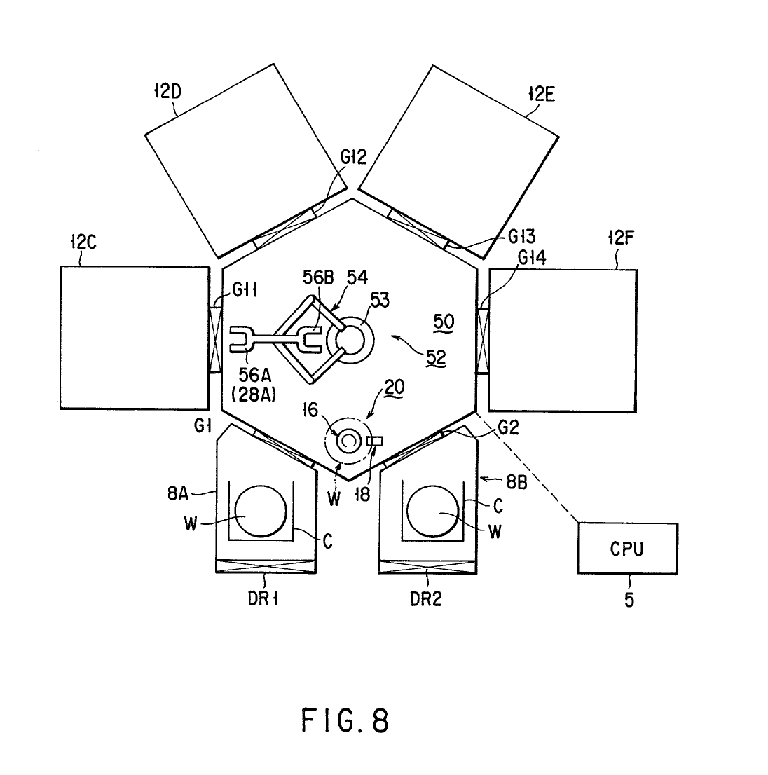

FIG. 8 is a schematic diagram showing a semiconductor processing system of a cluster-tool type, which includes a transfer apparatus according to another embodiment of the present invention. As shown in FIG. 8, this semiconductor processing system includes a transfer chamber 50 having a substantially hexagonal shape. The cassette chambers 8A and 8B respectively having cassette doors DR1 and DR2 are connected to two sides of the transfer chamber 50 through gate valves G1 and G2, respectively. Vacuum process chambers 12C to 12F are connected to the other four sides of the transfer chamber 50 through gate valves G11 to G14, respectively. The transfer chamber 50 is provided therein with a positioning mechanism 20 for a semiconductor wafer, which has a worktable 16 and an optical system 18, and a transfer apparatus 52 for transferring the wafer.

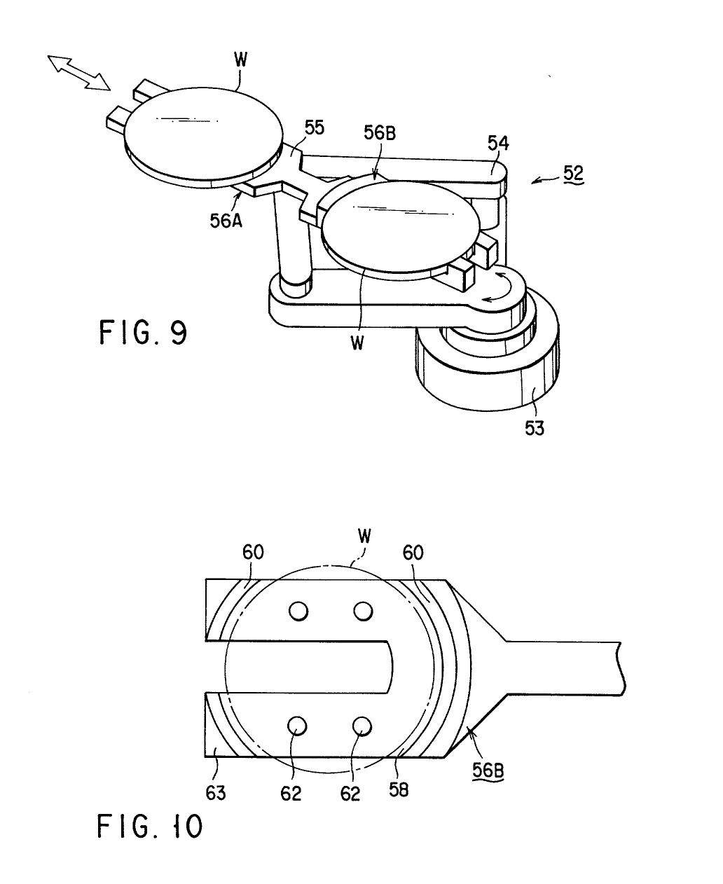

FIG. 9 is a perspective view showing the transfer apparatus 52. The transfer apparatus 52 includes a base 53 fixed at the center of the transfer chamber 50, an intermediate section disposed on the base 53 and arranged to be pivotable and extensible/contractible, and a pickup section connected to the intermediate section and arranged to engage with a wafer W. The intermediate section of the transfer apparatus 52 has a single common intermediate arm 54 disposed on the base 53 and arranged to be pivotable and extensible/contractible, by, e.g., a multi-joint mechanism. The pickup section has a common pick arm 55 connected to the common intermediate arm 54. The both ends of the common pick arm 55 are provided with first and second support portions 56A and 56B, respectively, facing in opposite directions and each for supporting the wafer W. The first and second support portions 56A and 56B have structures and functions different from each other.

The first support portion 56A is completely the same as the first support portion 28A of the transfer apparatus 6 described with reference to FIGS. 3 and 4, and thus no explanation will be given of the first support portion 56A.

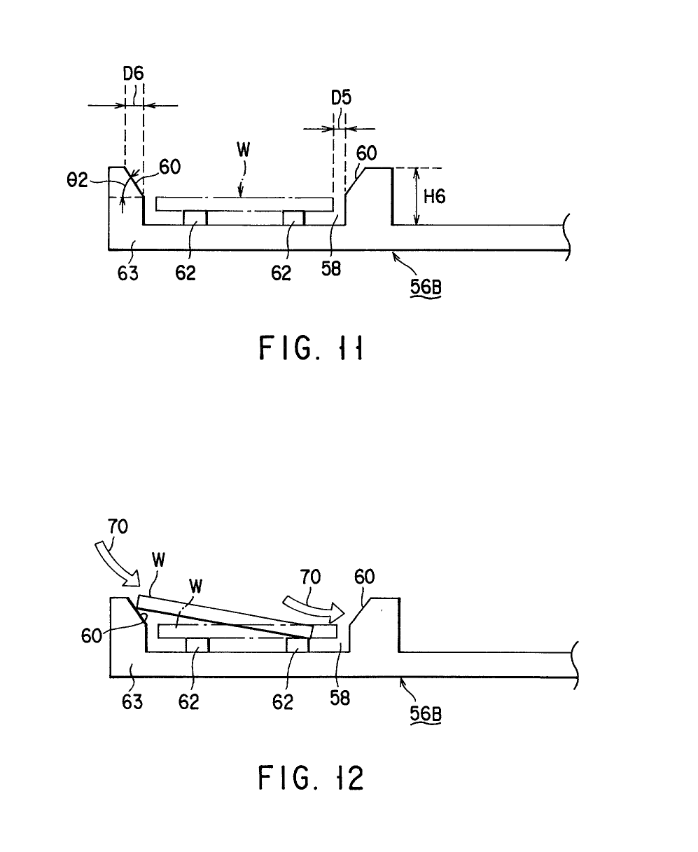

FIGS. 10 and 11 are a plan view and a side view, respectively, showing the second support portion 56B. The second support portion 56B has a support plate 63 with a distal end divided into two portions. The thickness H6 of the second support portion 56B is larger than that of the first support portion 56A, and is set at, e.g., about 4 mm. The second support portion 56B is provide with a receiving recess 58 having a circular contour, which is slightly larger than the plan-view contour of the wafer. The receiving recess 58 is arranged such that the wafer W falls into the receiving recess 58 and the positional shift of the wafer W is thereby corrected, when the wafer W is supported by the second support portion 56B. More specifically, the distance D5 (see FIG. 11) between the wall defining the recess 58 and the edge of the wafer at the normal position is set to be very small, such that it is, e.g., about 0.2 mm. Accordingly, the second support portion 56B can position the wafer W with a high precision.

Slant surfaces 60 are disposed along the periphery of the recess 58 and are inclined downward toward the recess 58. The slant surfaces 60 are made of a ceramic having a small friction coefficient, integrally with the support plate 63 of the second support portion 56B. When the wafer W is received by the second support portion 56B, part of the edge of the wafer W may be placed on the slant surfaces 60, if the wafer W has a positional shift. Even in such a case, the wafer W immediately slides down on the slant surfaces 60 and falls into the recess 58, and the positional shift of the wafer W is thereby corrected.

The tilting angle θ2 of the slant surfaces 60 is set to fall in a range of, e.g., from about 60° to 70°, so that the wafer W easily slides. The width D6 of the slant surfaces 60 in the horizontal direction is set at about 2 mm. The length of the slant surfaces 60 in the tilting direction is set to be large enough to cover the maximum tolerance for the positional shift of the wafer W. As a result, the second support portion 56B has a large thickness H6, as described above. The second support portion 56B is not used for accessing the cassette C, as described later, and thus the thickness H6 can be set without reference to the intervals of the wafers stacked and held in the cassette C.

On the bottom of the recess 58, there are three or more, in this embodiment, four, backside receiving members 62. The backside receiving members 62 are made of an elastic material having a high friction coefficient, such as silicone-based rubber. The backside receiving members 62 respectively have horizontal surfaces at the top ends. The horizontal surfaces of the backside receiving members 62 come into direct contact with the backside of the wafer W, so that they support the weight of the wafer W.

An explanation will be given of a manner of transferring a wafer W in the semiconductor processing system shown in FIG. 8. The operations described below of the transfer apparatus 52 and so forth for transferring the wafer W in the semiconductor processing system shown in FIG. 8 are controlled in accordance with a program stored in a CPU 5.

The wafer W is taken out from a cassette C by the transfer apparatus 52, and is subjected to a positioning operation at the positioning mechanism 20. Then, the wafer W is sequentially transferred to the process chambers, as needed. In the transfer operation, when the transfer apparatus 52 accesses the cassette C, i.e., when the new wafer W is taken out from the cassette C, and when the processed wafer W is transferred into the cassette C, the first support portion 56A having a smaller thickness is used. At another instance, i.e., when the wafer W is transferred between the process chambers 12C to 12F, e.g., when the wafer W is sequentially transferred from the process chamber 12C, to the process chamber 12D, to the process chamber 12E, and to the process chamber 12F, and when the wafer W is transferred from the positioning mechanism 20 to a predetermined one of the process chambers, the second support portion 56B having a function of correcting the positional shift is used.

The wafer W is transferred by the second support portion 56B, while it is received in the recess 58, as shown in FIGS. 10 and 11. Consequently, even when the wafer W laterally slides during transfer, the slide of the wafer W is blocked by the wall defining the recess 58, so that the wafer W is prevented from greatly positionally shifting. Furthermore, as shown in FIG. 12, when the wafer W is received by the second support portion 56B, part of the edge of the wafer W may be placed on the slant surfaces 60, if the wafer W has a positional shift. Even in such a case, the wafer W immediately slides down on the slant surfaces 60, as indicated by an arrow 70, and falls into the recess 58, as shown by one-dot chain lines, and the positional shift of the wafer W is thereby corrected. In other words, the second support portion 56B works as a support portion with a function of correcting the positional shift.

Since the wafer W is transferred between the process chambers 12C to 12F by the second support portion 56B, the positional shift of the wafer W is corrected every time even on a downstream side of the transfer route, and thus is not accumulated. As a result, the wafer is always positioned with a high precision in the process chambers 12c to 12F.

The transfer apparatuses 6 and 52 of the systems shown in FIGS. 1 and 8 are inter-exchangeable. Specifically, the system shown in FIG. 1 may employ the transfer apparatus 52 shown in FIG. 9, and the system shown in FIG. 8 may employ the transfer apparatus 6 shown in FIG. 2. Furthermore, the present invention may be applied to a target substrate other than a semiconductor wafer, such as an LCD substrate, or a glass substrate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A transfer apparatus for transferring a target substrate in a semiconductor processing system, comprising:
a common base;
an intermediate section disposed on the common base and configured to be pivotable and extensible/contractible; and
a pickup section connected to the intermediate section and having first and second support portions each configured to support the target substrate, the first and second support portions having functions different from each other.

2. The apparatus according to claim 1, wherein the intermediate section comprises first and second extensible/contractible arms configured to be extensible/contractible independently of each other, the pickup section comprises first and second pick arms connected to the first and second extensible/contractible arms, respectively, and the first and second support portions are arranged on the first and second pick arms, respectively.

3. The apparatus according to claim 2, wherein the intermediate section comprises a common rotational table disposed on the common base and configured to be rotatable, and the first and second extensible/contractible arms are disposed on the common rotational table.

4. The apparatus according to claim 1, wherein the intermediate section comprises a common intermediate arm disposed on the common base and configured to be pivotable and extensible/contractible, the pickup section comprises a common pick arm connected to the common intermediate arm, and the first and second support portions are respectively arranged on opposite ends of the common pick arm.

5. The apparatus according to claim 1, wherein the first support portion has a larger tolerance for a positional shift of the target substrate than the second support portion.

6. The apparatus according to claim 5, wherein positional shift tolerances of the first and second support portions are set to fall in a range of from 2 to 3 mm, and a range of from 0.1 to 0.3 mm, respectively.

7. The apparatus according to claim 5, wherein the first support portion has a smaller thickness than the second support portion.

8. The apparatus according to claim 5, wherein the first support portion comprises stoppers configured to surround the target substrate.

9. The apparatus according to claim 1, wherein only one of the first and second support portions has a function of preventing a positional shift of the target substrate.

10. The apparatus according to claim 9, wherein the function of preventing a positional shift of the target substrate is defined by a slant surface, on which an edge of the target substrate is supported.

11. The apparatus according to claim 1, wherein only one of the first and second support portions has a function of correcting a positional shift of the target substrate.

12. The apparatus according to claim 11, wherein the function of correcting a positional shift of the target substrate is defined by a slant surface, on which an edge of the target substrate slides down, so that the target substrate is positioned.

13. The apparatus according to claim 1, wherein the first support portion has a larger tolerance for a positional shift of the target substrate than the second support portion, and the second support portion has a function of preventing a positional shift of the target substrate.

14. The apparatus according to claim 1, wherein the first support portion has a smaller thickness than the second support portion, and the second support portion has a function of correcting a positional shift of the target substrate.

15. A semiconductor processing system comprising:
a transfer chamber;
a cassette chamber connected to the transfer chamber and configured to accommodate a cassette configured to hold a plurality of target substrates;
a vacuum processing section connected to the transfer chamber and configured to subject a target substrate to a process in a vacuum atmosphere;
a positioning mechanism disposed in or connected to the transfer chamber and configured to subject the target substrate to a positioning operation;
a transfer apparatus disposed in the transfer chamber and configured to transfer the target substrate between the cassette chamber, the vacuum processing section, and the positioning mechanism, the transfer apparatus comprising a common base, an intermediate section disposed on the common base and configured to be pivotable and extensible/contractible, and a pickup section connected to the intermediate section and having first and second support portions each configured to support the target substrate, the first and second support portions having functions different from each other; and
a control section configured to control the transfer apparatus.

16. The system according to claim 15, wherein the first support portion has a larger tolerance for a positional shift of the target substrate or a smaller thickness than the second support portion, and the second support portion has a function of preventing a positional shift of the target substrate or a function of correcting a positional shift of the target substrate, and
wherein the control section controls the transfer apparatus such that the fist support portion is used when the target substrate is transferred from the cassette chamber to the positioning mechanism, and the second support portion is used when the target substrate is transferred from the positioning mechanism to the vacuum processing section.

17. The system according to claim 16, wherein the vacuum processing section comprises a plurality of process chambers each configured to subject the target substrate to a process, and
wherein the control section controls the transfer apparatus such that the second support portion is used when the target substrate is transferred between the process chambers.

18. The system according to claim 15, wherein the intermediate section comprises first and second extensible/contractible arms configured to be extensible/contractible independently of each other, the pickup section comprises first and second pick arms connected to the first and second extensible/contractible arms, respectively, and the first and second support portions are arranged on the first and second pick arms, respectively.

19. The system according to claim 15, wherein the intermediate section comprises a common intermediate arm disposed on the common base and configured to be pivotable and extensible/contractible, the pickup section comprises a common pick arm connected to the common intermediate arm, and the first and second support portions are respectively arranged on opposite ends of the common pick arm.
